(19) United States
(12) Patent Application Publication
(10) Pub. No.: US 2019/0153910 A1
(43) Pub. Date: May 23, 2019

(54) VALVE OPENING/CLOSING TIMING CONTROL DEVICE

(71) Applicant: AISIN SEIKI KABUSHIKI KAISHA, Kariya-shi, Aichi (JP)

(72) Inventors: Takeo ASAHI, Kariya-shi, Aichi (JP); Yuji NOGUCHI, Obu-shi, Aichi (JP); Masaki KOBAYASHI, Okazaki-shi, Aichi (JP); Yoshiaki YAMAKAWA, Toyota-shi, Aichi (JP); Hiromitsu SHIGYO, Toyota-shi, Aichi (JP)

(73) Assignee: AISIN SEIKI KABUSHIKI KAISHA, Kariya-shi, Aichi (JP)

(21) Appl. No.: 15/571,451

(22) PCT Filed: Jun. 13, 2016
(86) PCT No.: PCT/JP2016/067478

§ 371 Date: Nov. 2, 2017

(30) Foreign Application Priority Data
Jun. 19, 2015 (JP) 2015-123997

(51) Int. Cl. F01L 1/356; F01L 1/344; F01L 1/047

(52) U.S. Cl. CPC F01L 1/356; F02D 13/02; F01L 1/047; F01L 1/3442

(57) ABSTRACT

A valve opening/closing timing control device is configured to implement controlling of a relative rotation phase and controlling of a lock mechanism by means of a small control valve. The valve opening/closing timing control device includes a first valve whose position is switched electromagnetically and a second valve whose position is switched by a fluid pressure controlled by the first valve. The second valve is constituted of at least one of a phase control valve that controls the relative rotation phase by providing an advance chamber or a retard chamber with an operating fluid from a fluid pressure pump and a lock control valve that controls a lock state of the lock mechanism by controlling the operating fluid from the fluid pressure pump.

### TECHNICAL FIELD

The present invention relates to a valve opening/closing timing control device configured to implement, through an operating fluid, controlling of a relative rotation phase between a driving rotary body and a driven rotary body as well as controlling of a lock mechanism that locks the relative rotation phase between the driving rotary body and the driven rotary body to a predetermined relative rotation phase.

### BACKGROUND ART

A valve opening/closing timing control device configured as above is known from e.g. Patent Document 1 disclosing a technique relating to an oil control valve configured such that a spool is accommodated to be operable along an axis inside a driven rotary body operably coupled with a cam shaft and an electromagnetic solenoid for operating the spool is mounted outside a rotary arrangement.

With this technique, in order to control the relative rotation phase through spool operation and to control also the lock mechanism, the valve opening/closing timing control device defines therein ports communicated to the advance chamber and the retard chamber as well as a port communicated to a locking member of the lock mechanism.

Patent Document 2 discloses a technique including a first switching valve for controlling a relative rotation phase between a driving rotary body and a driven rotary body through feeding/discharging of operating fluid to/from an advance chamber and a retard chamber and a second switching valve for controlling a lock mechanism through feeding/discharging of the operating fluid to/from the lock mechanism.

In the above technique, the first switching valve and the second switching valve respectively comprise an electromagnetic valve that is controlled by feeding/discharging of electric power to/from an electromagnetic solenoid and these valves are mounted outside the driving rotary body and the driven rotatory body.

Patent Document 3 discloses a technique according to which a relative rotation phase between a driving rotary body and a driven rotary body is controlled by controlling of fluid through a control valve having a spool mounted coaxially with a cam shaft and the fluid is controlled by a pilot valve mounted within the driven rotary body so as to control protrusion/retraction of a lock pin.

### CITATION LIST

### Patent Literature

Patent Document 1: Japanese Unexamined Patent Application Publication No. 2015-78635

Patent Document 2: Japanese Patent Publication No. 5267264

Patent Document 3: Japanese Translation of PCT International Application Publication No. 2011-513651

### SUMMARY OF INVENTION

### Technical Problem

The valve opening/closing timing control device has the controlling arrangement of displacing the relative rotation phase through feeding/discharging of operating fluid to/from the advance chamber and the retard chamber and the controlling arrangement of controlling a lock state of the lock mechanism through feeding/discharging of the operating fluid to/from a passage for controlling the lock mechanism.

Here, there will be contemplated a control valve having a spool which operates linearly in order to realize such control arrangements as above. The control valve arranged as above will require a plurality of ports including a pump port that receives supply of operating fluid from a fluid pressure pump, a drain port for discharging the fluid, an advance port communicated to the advance chamber, a retard port communicated to the retard chamber and a lock port communicated to a lock passage. With such configuration, the pump port, the advance port, the retard port and the lock port will be disposed along the operating direction of the spool with a predetermined spacing therebetween.

For realizing speedy displacement of the relative rotation phase and speedy operation of the lock mechanism, it is necessary to secure a predetermined aperture area for each port. For a reason similar thereto, it is also necessary to set the spacing of a plurality of lands formed in the spool to a predetermined spacing. However, these arrangements invite increase of the axial length of the spool, which in turn will lead to enlargement of the control valve.

In particular, in the case of the arrangement in which the control valve is provided inside the device as shown in Patent Document 1 and Patent Document 2, the distance between the advance chamber and the retard chamber relative to the control valve is shortened, thus shortening the distance from the lock mechanism to the control valve, for the sake of realization of highly responsive control. However, in actuality, with such arrangement as above, although compactization of the control valve is desirable, such compactization has not been made possible due to e.g. the increased length of the spool.

Further, while it is also conceivable to provide two kinds of electromagnetic valves within the device as shown in Patent Document 3, for controlling two kinds of electromagnetic valves, two sets of driver circuits are needed for supply electric power to the electromagnetic solenoids, so that cost increase would tend to incur. Moreover, there arises need to adjust an error of operational timing attributable to individual characteristics of the two kinds of electromagnetic valves. In this regard, there remains room for improvement.

In view of the above, there is a need for a valve opening/closing timing control apparatus capable of realizing control of a relative rotation phase and control of a lock mechanism by means of a compact control valve.

### Solution to Problem

According to a characterizing feature of the present invention, a valve opening/closing timing control device comprises:
a driving rotary body rotatable in synchronism with a crankshaft of an internal combustion engine;
a driven rotary body mounted coaxially with a rotational axis of the driving rotary body and rotatable in unison with a valve opening/closing cam shaft of the internal combustion engine;
an advance chamber and a retard chamber formed by partitioning a fluid pressure chamber defined between the driving rotary body and the driven rotary body by a partitioning portion formed in either one of the driving rotary body and the driven rotary body;
a lock mechanism switchable between a lock state for locking a relative rotation phase of the driven rotary body relative to the driving rotary body to a predetermined lock phase and a lock releasing state for releasing the locking;
a first valve whose position is changeable electromagnetically; a second valve whose position is changeable by a fluid pressure controlled by the first valve; and
the second control valve being constituted of at least one of a phase control valve configured to control the relative rotation phase by feeding an operating fluid fed from a fluid pressure pump to the advance chamber or the retard chamber and a lock control valve configured to control the lock state of the lock mechanism by feeding the operating fluid fed from the fluid pressure pump to the lock mechanism.

In the case of an arrangement exemplifying the above-described configuration in which the position of the phase control valve is switched by the fluid pressure provided by the first control valve, the relative rotation phase can be controlled by directly feeding the operating fluid from the fluid pressure pump to either the advance chamber or the retard chamber in operable association with the operation of the first valve. Also, as for the arrangement in which the position of the lock control valve is switched by the fluid pressure controlled by the first valve, the lock state can be controlled by directly feeding the operating fluid from the fluid pressure pump to the lock mechanism in operative association with the operation of the first valve. Namely, the first valve needs to form only a port whose passage area for applying the fluid pressure can be small. In comparison with e.g. the arrangement thereof for implementing the control of relative rotation phase and the control of lock mechanism, the valve can be formed small as the port for feeding/discharging operating fluid to/from the advance chamber or the retard chamber and the port for feeding/discharging the operating fluid to/from the lock mechanism are not needed. Further, in comparison with the second valve whose position is switched electromagnetically, no electromagnetic solenoid is needed, so that its arrangement can be simple and of low cost. Consequently, there has been provided a valve opening/closing timing control apparatus capable of realizing control of a relative rotation phase and control of a lock mechanism by means of a compact control valve.

According to a further arrangement, an advance port communicated to the advance chamber, a retard port communicated to the retard chamber and a pilot pressure port for controlling the fluid pressure together constituting the phase control valve are included in the first valve, the lock control valve is configured as the second valve whose position is switched by the fluid pressure from the pilot pressure port.

With the above-described arrangement, feeding and discharging of the operating fluid to/from the advance chamber and the retard chamber can be done directly by electromagnetically switching the position of the first valve. And, the control of the lock mechanism is realized by switching the position of the lock control valve as the second valve by the fluid pressure from the pilot pressure port in operative association with this position switching of the first valve.

According to a further alternative arrangement, the first valve is arranged such that the advance port and the retard port are disposed in parallel with each other and the pilot pressure port is disposed at a position in subsequent juxtaposition to the advance port and the retard port.

With the above-described arrangement, even if the pilot pressure port is exposed to influence of an amount of operating fluid which may leak from a port adjacently positioned one of the advance port and the retard port, there will occur no situation of the pilot pressure port being exposed to influence of the operating fluid leaking from both the advance port and the retard port.

According to a further alternative arrangement, a check valve is incorporated in at least one of a passage that feeds the operating fluid from the fluid pressure pump to the first valve and a passage that feeds the operating fluid from the fluid pressure pump to the second valve.

With the above-described arrangement, a momentary pressure drop in the passage incorporating the check valve can be effectively suppressed for ensuring smooth operation, even when momentary pressure drop can occur e.g. in a situation such as feeding of operating fluid to the other passage being started in the course of feeding of the operating fluid to the passage incorporating the check valve.

According to a further alternative arrangement:
the lock mechanism includes a lock member that is caused to urgingly protrude from the driving rotary body by a lock urging member and a lock recess that is formed in the driven rotary body to be engageable with the lock member;
the driven rotary body is coupled with the camshaft via a connecting bolt; and the lock control valve is provided at another portion of the driven rotary body than the connecting bolt.

With the above-described arrangement, as the lock control valve is provided at another portion of the driven rotary body than the connecting bolt, feeding and discharging of the operating fluid can be done from a position close to the lock mechanism. Further, as the lock control valve is disposed at a position off the rotational axis, a phase control valve can be disposed on the rotational axis.

According to a further alternative arrangement, the lock control valve includes a valve body that is movably inserted to a hole portion that is defined in the driven rotary body along an axis extending parallel with the rotational axis.

With the above-described arrangement, even when a centrifugal force is applied to the valve body in association with rotation of the valve opening/closing timing control device, as this centrifugal force is effective in the direction perpendicular to the moving direction of the valve body, there will occur no inconvenience of the valve body, when uncontrolled, being moved to effect feeding/discharging of the operating fluid to/from the lock mechanism.

According to a further alternative arrangement:
a lock releasing passage that releases the lock state by feeding the operating fluid from the lock control valve to the lock mechanism, a lock draining passage that maintains the lock state by discharging the operating fluid from the lock mechanism via the lock control valve and a pilot passage that applies a pilot pressure to the lock control valve are formed in the driven rotary body; and
the lock releasing passage, the lock draining passage and the pilot passage are formed parallel with each other in the above-recited order.

With the above-described arrangement, in the event of leak of the operating fluid that applies the pilot pressure to the pilot passage, such leaked operating fluid may enter the lock draining passage, but this leaked operating fluid will not enter the lock releasing passage. Namely, even if the operating fluid leaks from the pilot passage, this operating fluid will not invite inconvenience of adversely affecting the lock state by entering the the lock draining passage.

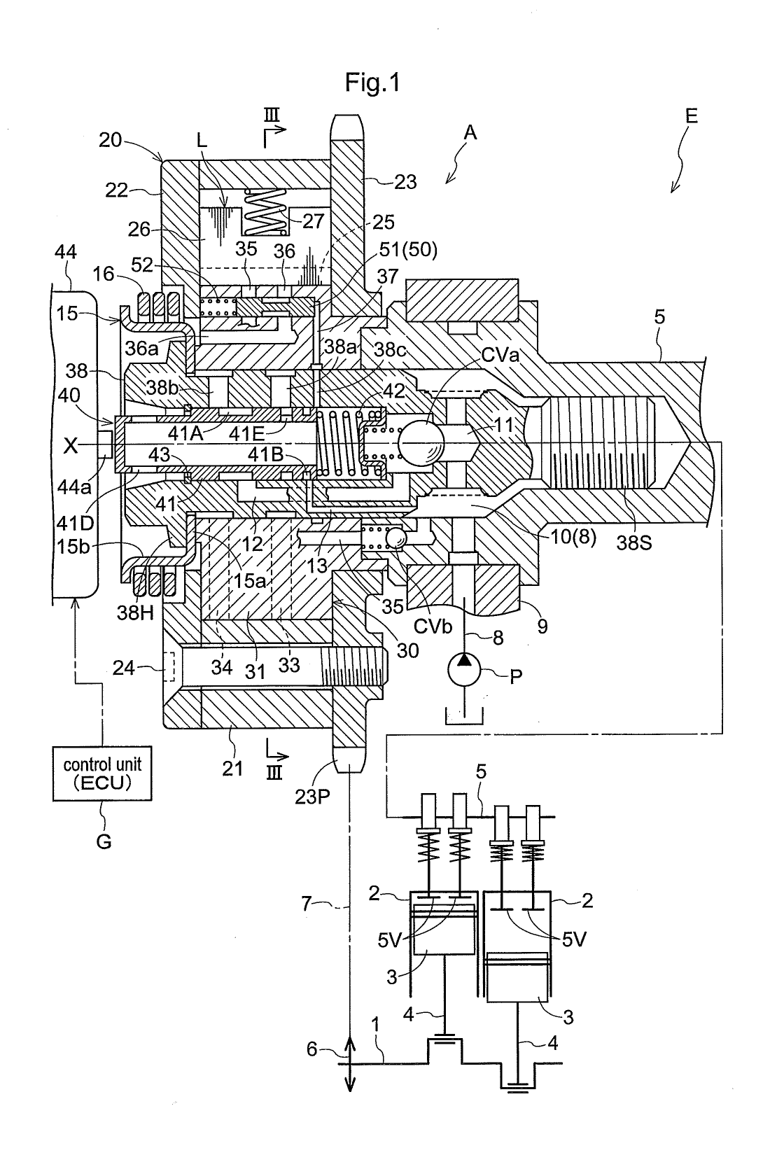

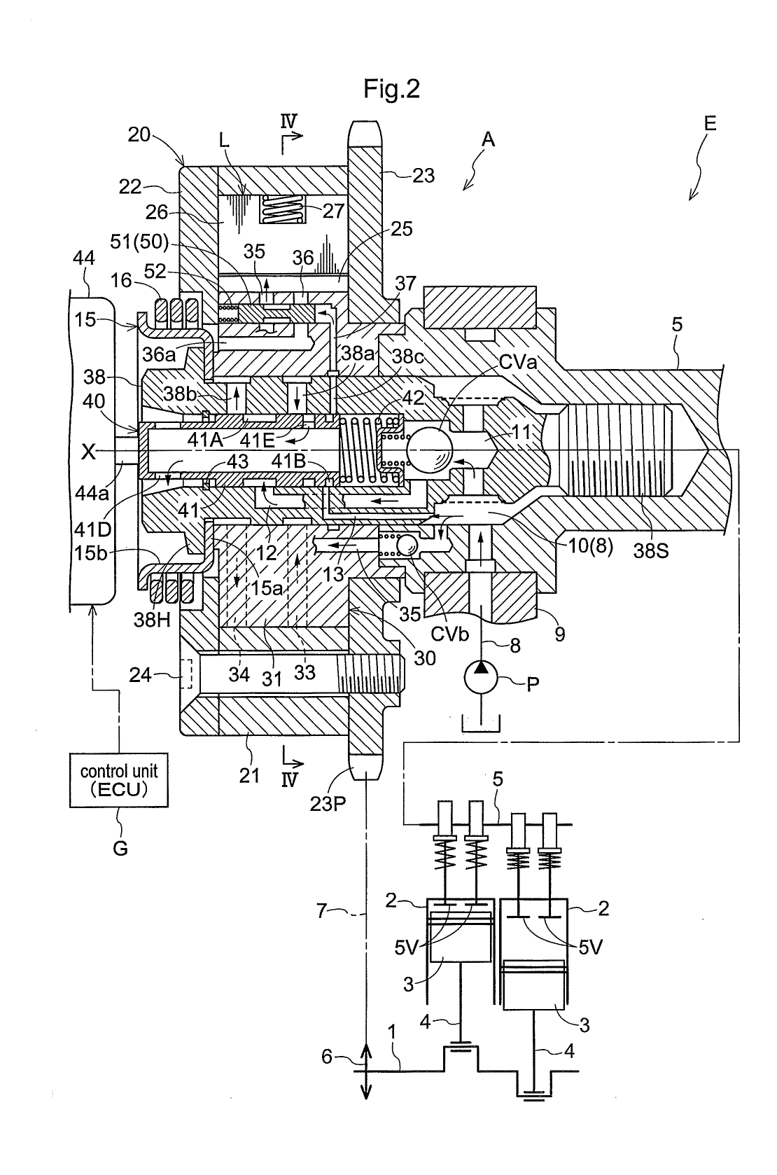

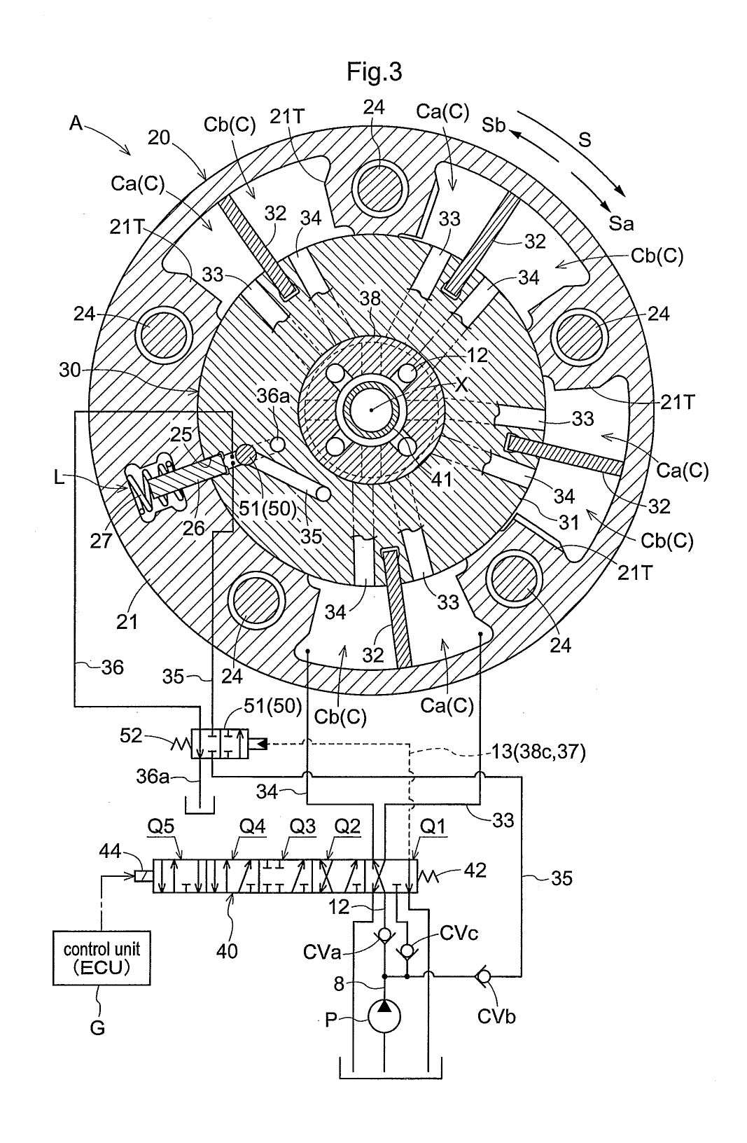

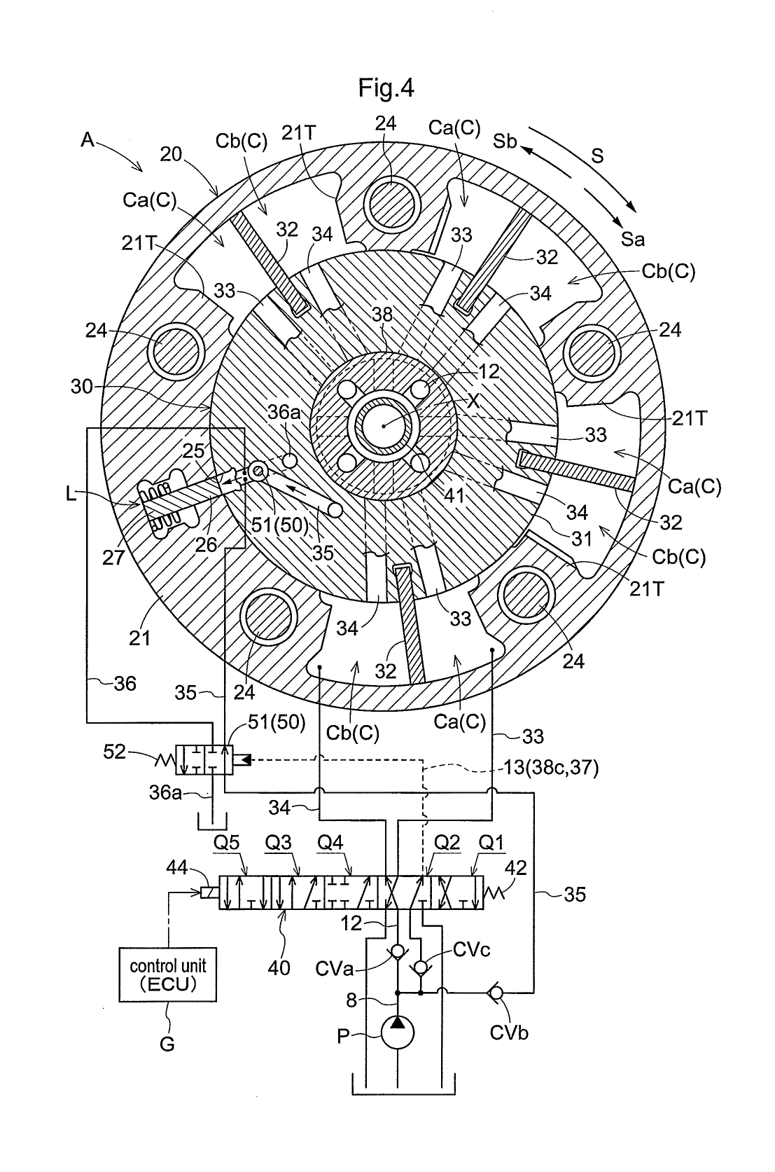

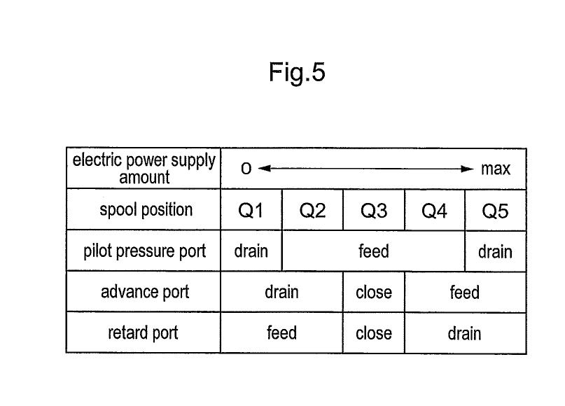

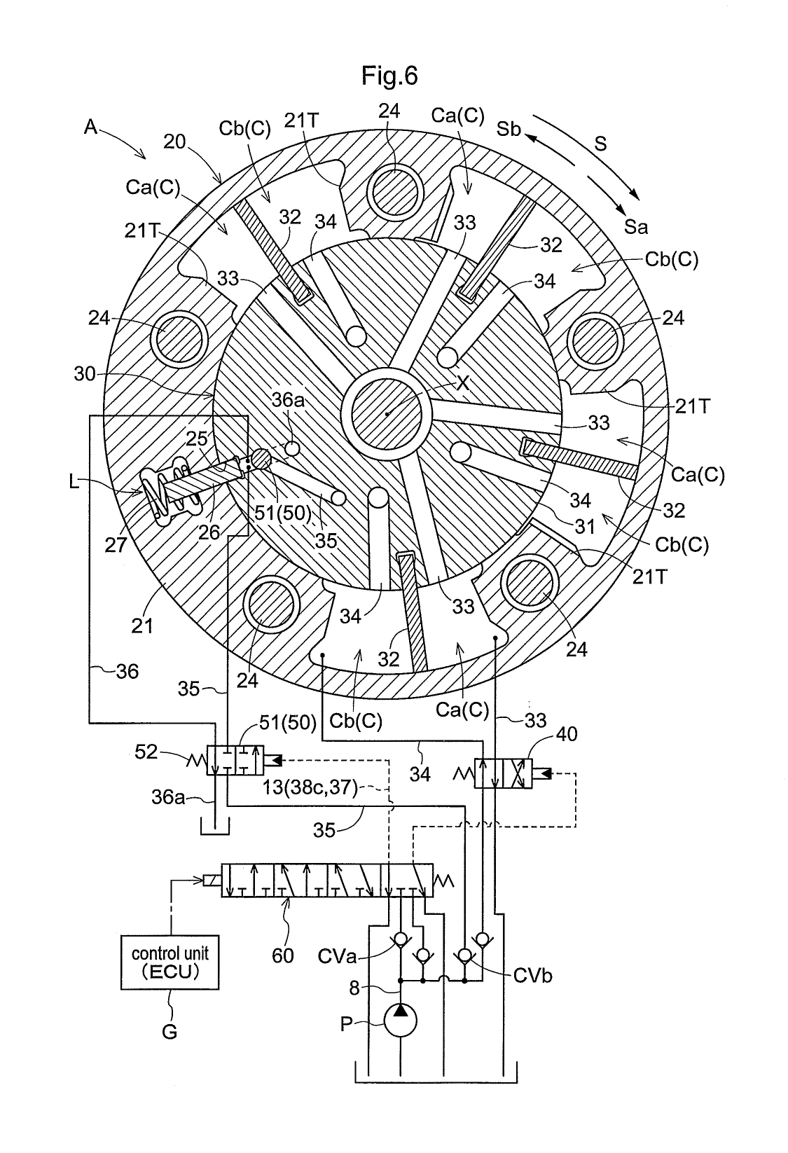

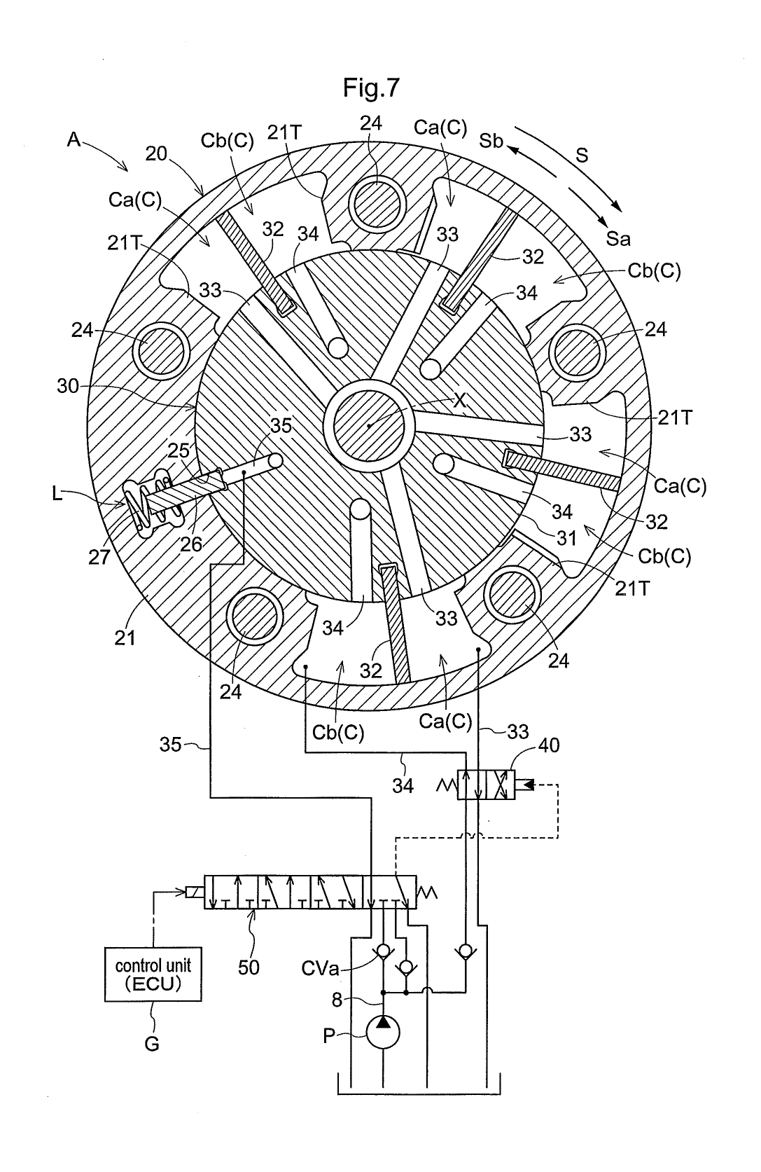

### BRIEF DESCRIPTION OF DRAWINGS

[FIG. 1] is a section view showing a valve opening/closing timing control device when a lock control valve is located at a lock position,

[FIG. 2] is a section view showing the valve opening/closing timing control device when the lock control valve is located at a lock releasing position,

[FIG. 3] is a section taken along III-III line in FIG. 1,

[FIG. 4] is a section taken along IV-IV line in FIG. 2,

[FIG. 5] is a view showing relationship between respective positions and ports of a phase control valve,

[FIG. 6] is a view showing a valve opening/closing timing control device according to a further embodiment (a), and

[FIG. 7] is a view showing a valve opening/closing timing control device according to a further embodiment (b).

### DESCRIPTION OF EMBODIMENT

Next, an embodiment of the present invention will be explained with reference to the accompanying drawings.

### [Basic Configuration]

As shown in FIG. 1 and FIG. 2, a valve opening/closing timing control device A is configured such that an outer rotor 20 (an example of “driving rotary body”) rotatable in synchronism with a crankshaft 1 of an engine E as an internal combustion engine and an inner rotor 30 (an example of “driven rotary body”) rotatable in unison with an intake cam shaft 5 of a combustion chamber of the engine E are provided to be rotatable relative to each other about a rotational axis X of the intake cam shaft 5.

In the valve opening/closing timing control device A, the outer rotor 20 (driving rotary body) encloses the inner rotor 30 (driven rotary body) and at a center position of the inner rotor 30, there is provided an electromagnetic type phase control valve 40 as a “first valve” coaxially with the rotational axis X. This inner rotor 30 is coupled with the intake cam shaft 5 via a connecting bolt 38 mounted coaxially with the rotational axis X. And, at a position on the outer side of this connecting bolt 38, there is provided a pilot-pressure operating type lock control valve 50 acting as a “second valve”.

Incidentally, in the case of the above configuration, as the first valve whose position is electromagnetically switched is provided with the function of the phase control valve 40, this first valve is adapted to act also as the phase control valve 40; and the lock control valve 50 is provided as an example of the second valve whose position is switched by an oil pressure (fluid pressure) controlled by the first valve.

With the above valve opening/closing timing control device A in operation, a control unit G acting as an ECU controls electric power to be fed to an electromagnetic solenoid 44 of the phase control valve 40 (an example of the “first valve”), this phase control valve 40 (first valve) can be switched to one of a plurality of positions. As this controls an operating oil (an example of “operating fluid”) from a hydraulic pump P (an example of “fluid pressure pump”), a relative rotation phase between the outer rotor 20 and the inner rotor 30 (to be referred to as “relative rotation phase” hereinafter) is changed, thus realizing control of an opening/closing timing of an intake valve 5V.

The phase control valve 40 as being set to one of the plurality of positions is also configured to control a pilot pressure (a fluid pressure). Through such control of the pilot pressure, the lock control valve 50 (second valve) is switched to a lock position shown in FIG. 1 or a lock releasing position shown in FIG. 2. With this, the operating oil from the hydraulic pump P (fluid pressure pump) is controlled, thus controlling a lock state of a lock mechanism L.

The engine E (an example of “internal combustion engine”) shown comprises one to be mounted in e.g. a passenger automobile or the like.

This engine E is configured as a four-cycle engine wherein a crankshaft 1 is provided at a lower portion thereof and a piston 3 is accommodated within a cylinder bore defined in a cylinder block 2 provided at a position upwardly of the crankshaft 1, and the piston 3 and the crankshaft 1 are connected to each other via a connecting rod 4.

Upwardly of the engine E, there are provided an intake cam shaft 5 for opening/closing the intake valve 5V and an exhaust cam shaft for opening/closing an exhaust valve; and the engine E includes the hydraulic pump P (an example of “fluid pressure pump”) driven by a drive force of the crankshaft 1. The hydraulic pump P employs lubricant oil reserved in an oil pan of the engine E as the operating oil and feeds this operating oil to the phase control valve 40 and the lock control valve 50 via a feed passage 8.

A length of timing chain 7 is entrained around an output sprocket 6 formed on the crankshaft 1 of the engine E and a timing sprocket 23P. With this, the outer rotor 20 is rotated in synchronism with the crankshaft 1. Though not shown, a timing sprocket is provided also at a front end of an exhaust side cam shaft and the timing chain 7 is entrained around this sprocket also.

As shown in FIG. 3 and FIG. 4, with the valve opening/closing timing control device A, the outer rotor 20 is rotated to a driving rotation direction S by the driving force of the crankshaft 1. Also, the direction of relative rotation of the inner rotor 30 relative to the outer rotor 20 in the same direction as the driving rotation direction S will be referred to as an advance direction Sa and a direction opposite thereto will be referred to as a retard direction Sb. With this valve opening/closing timing control device A, the relationship between the crankshaft 1 and the intake cam shaft 5 is set such that when the relative rotation phase is displaced in the advance direction Sa, an intake compression ratio is increased in association with increase of the displacement amount, whereas, when the relative rotation phase is displaced in the retard direction Sb, the intake compression ratio is decreased in association with increase of the displacement amount.

Incidentally, in the instant embodiment, the valve opening/closing timing control device A is included in the intake cam shaft 5. However, the valve opening/closing timing control device A can alternatively be included in the exhaust cam shaft or in both the intake cam shaft 5 and the exhaust cam shaft.

### [Valve Opening/Closing Timing Control Device]

As shown in FIGS. 1 through 4, the outer rotor 20 includes an outer rotor body 21, a front plate 22 and a rear plate 23; and these members are integrated to each other by fastening of a plurality of fastening bolts 24. With this fastening, the inner rotor 30 is mounted at the position sandwiched between the front plate 22 and the rear plate 23. Further, the timing sprocket 23P is formed in the outer circumference of the rear plate 23.

The outer rotor body 21 integrally forms a plurality of protruding walls 21T that protrude to the radially inner side relative to the rotational axis X. Further, the inner rotor 30 includes a cylindrical inner rotor body 31 placed in gapless contact with the protruding ends of the protruding walls 21T of the outer rotor body 21 and a plurality of (four) vanes 32 that protrude from the outer circumference of the inner rotor body 31 in such a manner to come into contact with the inner circumferential face of the outer rotor body 21.

As the inner rotor 30 is enclosed by the outer rotor 20, a plurality of fluid pressure chambers C are formed at intermediate positions of the protruding walls 21T adjacent each other in the rotational direction and on the outer circumference side of the inner rotor body 31. And, as these fluid pressure chambers C are partitioned by the vanes 32 (an example of “partitioning portion(s)”), advance chambers Ca and retard chambers Cb are formed.

With the above-described arrangement, when the operating oil is fed to the advance chamber Ca, the relative rotation phase is displaced in the advance direction Sa. When the operating oil is fed to the retard chamber Cb, the relative rotation phase is displaced in the retard direction Sb.

The inner rotor 30 defines a bore portion centering about the rotational axis X and the connecting bolt 38 is inserted in this bore portion. The connecting bolt 38 includes a bolt head portion 38H and a male thread portion 38S. As this male thread portion 38S is threaded to a female thread portion of the intake cam shaft 5, the inner rotor 30 is coupled to the intake cam shaft 5.

The connecting bolt 38 is provided in form of a tube centering about the rotational axis X. And, within its inner space, a phase control spool 41 of the phase control valve 40 is accommodated. The arrangement of the phase control valve 40 will be described later herein.

The lock mechanism L includes a lock recess 25 formed in the inner rotor 30 on the outer side of the inner rotor body 31, a plate-like lock member 26 that is supported to be protrudable/retractable in the radial direction relative to the protruding walls 21T of the outer rotor 20, and a lock spring 27 (an example of “lock urging member”) that urges the lock member 26 towards the lock recess 25.

With this lock mechanism L in operation, the relative rotation phase is locked to an intermediate lock phase in association with engagement of the leading end of the lock member 26 into the lock recess 25. In the instant embodiment, the lock state can be provided not only by the intermediate lock phase, but also by a most advanced phase or a most retarded phase, etc. Also, with this lock mechanism L, with maintenance of a state of the operating oil being fed to the lock recess 25, a lock releasing state is maintained wherein the lock member 26 is detached from the lock recess 25.

Incidentally, the most advanced phase is the relative rotation phase realized when the vane 32 reaches the operational end in the advance direction Sa (including the phase of the vane 32 adjacent the operational end in the advance direction Sa); whereas, the most retarded phase is the relative rotation phase realized when the vane 32 reaches the operational end in the retard direction Sb (including the phase of the vane 32 adjacent the operational end in the retard direction Sb).

As shown in FIG. 1, a torsion spring 16 supported to a spring holder 15 is provided for applying an urging force to displace the relative rotation phase between the outer rotor 20 and the inner rotor 30 from the most retarded phase to the intermediate lock phase.

The spring holder 15 includes a bottom wall 15a engaged with the inner rotor 30 and a tubular holder body 15b protruding outwards. The torsion spring 16 is mounted in an area surrounding the holder body 15b and has its base end portion engaged to the front plate 22 and has its leading end portion engaged to the holder body 15b. With this, the torsion spring 16 provides an urging force in the direction from the most retarded phase to the intermediate phase.

### [Valve Opening/Closing Timing Control Device: Oil Passage Arrangement]

The inner rotor body 31 defines an advance passage 33 communicated to the advance chamber Ca and a retard passage 34 communicated to the retard chamber Cb. Further, the inner rotor body 31 defines a lock releasing passage 35 and a lock drain passage 36 communicated to the lock recess 25.

The lock drain passage 36 is communicated to a drain passage 36a for discharging the operating oil from the lock control valve 50. Further, the inner rotor body 31 defines a pilot passage 37 for operating the lock control valve 50.

The feed passage 8 for feeding the operating oil from the hydraulic pump P is communicated to an annular space 10 formed inside the intake cam shaft 5 and in the outer circumference of the connecting bolt 38, via a joint 9 which is rotatably fitted on the intake cam shaft 5.

Inside the connecting bolt 38, there is formed a feeding space 11 communicated to the annular space 10 (feed passage 8). Inside the connecting bolt 38, there is provided a main check valve CVa consisting of a spring and a ball and configured to be opened in association with rise of pressure of the feeding space 11 so as to feed the operating oil to a first pump passage 12. Further, there are formed a second pump passage 13 which receives supply of the operating oil of the annular space 10 (feeding passage 8) and a lock releasing passage 35. The second pump passage 13 is formed in the connecting bolt 38.

The lock releasing passage 35 is formed in the region that extends from the intake cam shaft 5 to the inner rotor body 31. And, this lock releasing passage 35 incorporates a lock check valve CVb which checks reverse flow of the operating oil. Further, as shown in FIG. 3 and FIG. 4 (not shown in FIG. 1 or FIG. 2), the second pump passage 13 which receives the operating oil from the hydraulic pump P incorporates a pressure maintaining check valve CVc for maintaining the pilot pressure.

Incidentally, FIG. 3 and FIG. 4 show the phase control valve 40 and the lock control valve 50 as seen in sections and show the phase control valve 40 and the lock control valve 50 in the form of symbols in the oil circuit. And, FIG. 6 relating to a further embodiment (a) shows the lock control valve 50 as seen in its section and shows the lock control valve 50 in the form of symbol in the oil circuit.

### [Phase Control Valve]

As shown in FIG. 1 and FIG. 2, the phase control valve 40 consists essentially of the phase control spool 41, a spool spring 42 and the electromagnetic solenoid 44. The phase control spool 41 is mounted in the inner space of the connecting bolt 38 to be slidable in the direction along the rotational axis X. The connecting bolt 38 includes a stopper 43 formed of a stopper ring arranged to determine an operational position at the outer end side of the phase control spool 41. The spool spring 42 applies an urging force for urging this phase control spool 41 in the direction away from the intake cam shaft 5.

The electromagnetic solenoid 44 is mounted outside the valve opening/closing timing control device A and includes a plunger 44a that protrudes by an amount in direct proportion to an amount of electric power supplied to the solenoid provided therein. By a pressing force from this plunger 44a, the phase control spool 41 is operated.

In the above-described arrangement, the phase control spool 41 and the spool spring 42 are rotated in unison with the inner rotor 30 and the electromagnetic solenoid 44 is non-rotatably supported to the engine E.

The inside of the phase control spool 41 is formed hollow, and at the protruding end of the phase control spool 41, there is formed a drain hole 41D communicated to the inner space described above. In the outer circumference of the phase control spool 41, a first groove portion 41A communicable to the first pump passage 12 and a second groove portion 41B communicable to the second pump passage 13 are provided in the form of grooves extending over the whole circumference. Further, at a mid position between the first groove portion 41A and the second groove portion 41B, there is formed a first drain hole 41E communicated to the inner space of the phase control spool 41.

The connecting bolt 38 defines an advance port 38a communicated to the advance passage 33, a retard port 38b communicated to the retard passage 34, and a pilot pressure port 38c communicated to the pilot passage 37.

With this phase control valve 40 in operation, as shown in FIGS. 3 through 5, when no power is fed to the electromagnetic solenoid 44 and the pressing force of the plunger 44a of this electromagnetic solenoid 44 is not effective (see FIG. 1), the phase control spool 41 is maintained at a first control position 01. And, in association with progressive increase of the electric power supply (electric power) to the electromagnetic solenoid 44, the phase control spool 41 will be maintained to a second control position Q2, a third control position Q3, a fourth control position 04 and to a fifth control position Q5.

### [Lock Control Valve]

The lock control valve 50 is configured to be two-position switchable between a lock position and a lock releasing position as described hereinbefore and is mounted outwardly of the connecting bolt 38 (the position other than the connecting bolt 38 and away from the rotational axis X) disposed centrally of the inner rotor 30. As a specific arrangement, the lock control valve 50 includes a lock control spool 51 (an example of “valve body”) slidably housed within a spool hole (an example of “hole portion”) defined in the inner rotor 30 at a position adjacent the lock recess 25 under a posture parallel with the rotational axis X and a return spring 52.

The lock control spool 51 forms a groove portion in the form of a groove extending along the entire circumference at the center position in the longitudinal direction, thus forming land portions on at the opposed end portions. In the spool hole, the lock releasing passage 35 and the lock drain passage 36 are connected at positions different from each other. Further, in the spool hole, to the end portion thereof opposite to the end portion where the return spring 52 is provided, the pilot passage 37 is communicated.

With the above-described arrangement, in the case of absence of the effect of the pilot pressure from the pilot passage 37, the lock control spool 51 is maintained to the lock position shown in FIG. 1 by the urging force of the return spring 52. With this, the operating oil of the lock drain passage 36 is discharged into the drain passage 36a, whereby the lock mechanism L is maintained under the lock state.

On the other hand, in the case of presence of the effect of the pilot pressure from the pilot passage 37, the lock control spool 51 is set to the lock releasing position shown in FIG. 2, against the urging force of the return spring 52. In response to this, the operating oil is fed into the lock releasing passage 35, so that the lock state of the lock mechanism L is released.

### [Control Mode: First Control Position]

In the state where no electric power is fed to the electromagnetic solenoid 44 under the control of the control unit G, the phase control spool 41 is maintained at the first control position Q1 shown in FIG. 3. Incidentally, as shown in FIG. 1, the first control position Q1 is the position at which the phase control spool 41 reaches a position in contact with the stopper 43, by the urging force of the spool spring 42.

At this first control position Q1, of the operating oil fed from the hydraulic pump P to the first groove portion 41A, the operating oil is fed from the retard port 38b via the retard passage 34 to the retard chamber Cb and also, the operating oil is discharged from the advance chamber Cl via the advance port 38a and the advance passage 33 to the first drain hole 41E.

Also, the operating oil which has been fed from the hydraulic pump P to the second groove portion 41B will not flow into the pilot pressure port 38c, and as this pilot pressure port 38c is communicated to the inside space of the phase control spool 41 via the inner end portion of the phase control spool 41, the pilot pressure of the pilot passage 37 is low (zero pressure), and the lock control spool 51 is maintained at the lock position shown in FIG. 1 by the urging force of the return spring 52.

At this lock positon, the lock releasing passage 35 is closed and the lock drain passage 36 is communicated to the drain passage 36a, so that the lock mechanism L will reach a state shiftable to the lock state. Therefore, if the lock mechanism L is already under the lock state, this lock state will be maintained. Further, if the lock mechanism L is not under the lock state, at the timing when the relative rotation phase reaches the intermediate lock phase, the lock member 26 will come into engagement with the lock recess 25 under the urging force of the lock spring 27, whereby the lock mechanism L is shifted to the lock state.

### [Control Mode: Second Control Position]

In response to initial increase of the electric power supply to the electromagnetic solenoid 44, the phase control spool 41 is maintained at the second control position Q2 against the urging force of the spool spring 42. Incidentally, as shown in FIG. 2, the second control position Q2 is the positon at which the spool has been slightly displaced against the urging force of the spool spring 42.

At this second control position Q2, in the operating oil to be fed from the hydraulic pump P to the first groove portion 41A, the operating oil is fed from the retard port 38b via the retard passage 34 to the retard chamber Cb and also the operating oil of the advance chamber Ca is discharged from the advance port 38a via the advance passage 33 into the first drain hole 41E.

Also, the operating oil which has been fed from the hydraulic pump P to the second groove portion 41B will flow into the pilot pressure port 38c, the pilot pressure of the pilot passage 37 will rise to the pump pressure, and the lock control spool 51 will be operated to the lock releasing position against the urging force of the return spring 52.

At this lock releasing positon, the lock releasing passage 35 is communicated and the lock drain passage 36 is closed, so that the operating oil is fed to the lock recess 25. With this, the lock member 26 is detached from the lock recess 25 against the urging force of the lock spring 27, thus releasing the lock state of the lock mechanism L and the relative rotation phase is displaced in the retard direction Sb by the operating oil fed from the hydraulic pump P to the retard chamber Cb.

### [Control Mode: Third Control Position]

In response to further increase of the electric power supply to the electromagnetic solenoid 44, the phase control spool 41 is maintained at the third control position Q3 shown in FIG. 5 against the urging force of the spool spring 42.

At this third control position Q3, both the advance port 38a and the retard port 38b are closed, so that the operating oil from the hydraulic pump P will be fed to neither the advance port 38a nor the retard port 38b and the operating oil will be discharged from neither of the ports, either.

Also, the operating oil which has been fed from the hydraulic pump P to the second groove portion 41B will flow into the pilot pressure port 38c, so the pilot pressure of the pilot passage 37 will rise to the pump pressure, and the lock control spool 51 is maintained at the lock releasing position shown against the urging force of the return spring 52.

At this lock releasing positon, although the lock state of the lock mechanism L is released, since no operating oil is fed/discharged to/from the advance chamber Ca and the retard chamber Cb, the relative rotation phase is maintained.

### [Control Mode: Fourth Control Position]

In response to still further increase of the electric power supply to the electromagnetic solenoid 44, the phase control spool 41 is maintained at the fourth control position Q4 shown in FIG. 5 against the urging force of the spool spring 42.

At this fourth control position Q4, in the operating oil to be fed from the hydraulic pump P to the first groove portion 41A, the operating oil is fed from the advance port 38a via the advance passage 33 to the advance chamber Ca and also the operating oil of the retard chamber Cb is discharged from the retard port 38b via the retard passage 34 to the front end side of the phase control spool 41.

Also, the operating oil which has been fed from the hydraulic pump P to the second groove portion 41B will flow into the pilot pressure port 38c, so the pilot pressure of the pilot passage 37 will rise to the pump pressure, and the lock control spool 51 is maintained at the lock releasing position shown against the urging force of the return spring 52.

At this lock releasing positon, the lock releasing passage 35 will be communicated and also the lock drain passage 36 is closed, so that the operating oil is fed to the lock recess 25. With this, the lock member 26 is detached from the lock recess 25 against the urging force of the lock spring 27, thus releasing the lock state of the lock mechanism L, so that the relative rotation phase is displaced in the advance direction Sa by the operating oil fed from the hydraulic pump P to the advance chamber Ca.

### [Control Mode: Fifth Control Position]

In response to maximal increase of the electric power supply to the electromagnetic solenoid 44, the phase control spool 41 is maintained at the fifth control position Q5 shown in FIG. 5 against the urging force of the spool spring 42.

At this fifth control position Q5, in the operating oil to be fed from the hydraulic pump P to the first groove portion 41A, the operating oil is fed from the advance port 38a via the advance passage 33 to the advance chamber Ca and also the operating oil of the retard chamber Cb is discharged from the retard port 38b via the retard passage 34 to the front end side of the phase control spool 41.

Also, the operating oil which has been fed from the hydraulic pump P to the second groove portion 41B will not flow into the pilot pressure port 38c and this pilot pressure port 38c is communicated to the first drain hole 41E. So, the pilot pressure of the pilot passage 37 is low (zero pressure), and the lock control spool 51 is maintained at the lock position by the urging force of the return spring 52.

At this lock positon, the lock releasing passage 35 is closed and the lock drain passage 36 is communicated to the drain passage 36a, so that the lock mechanism L will reach a state shiftable to the lock state. Therefore, if the lock mechanism L is already under the lock state, this lock state will be maintained. Further, if the lock mechanism L is not under the lock state, at the timing when the relative rotation phase reaches the intermediate lock phase, the lock member 26 will come into engagement with the lock recess 25 under the urging force of the lock spring 27, whereby the lock mechanism L is shifted to the lock state.

### [Effect of Embodiment]

In the case of e.g. an arrangement wherein the phase control valve 40 effects feeding/discharging of operating oil to/from the lock recess 25, this arrangement will invite increase of the size of the phase control valve 40 in the axial direction in order to maintain the passage area of the port used for feeding/discharging of operating oil to/from the lock mechanism L at a predetermined value.

On the other hand, with the valve opening/closing timing control device A according to the above embodiment, the lock control valve 50 acting as the second valve is operated by a pilot pressure and effects switchover between application and non-application of the pilot pressure to the phase control valve 40 acting as the first valve. Therefore, the embodiment arrangement requires only the pilot pressure port 38c of a relatively small diameter, so that the phase control spool 41 can be formed shorter in the direction along the axis. In particular, in the case of the arrangement as disclosed in the above embodiment in which the phase control valve 40 is provided inside the valve opening/closing timing control device A, compactization of the valve opening/closing timing control device A is realized.

Further, it is also possible to dispose the lock control valve 50 at a position close to the lock recess 25 as provided in the above embodiment. With such disposing of the lock control valve 50 as above, it is also possible to form a passage for feeding operating oil from the hydraulic pump P to the lock control valve 50, so when the lock state of the lock mechanism L is to be released, this lock releasing can be effected speedily by applying the pressure of the operating oil to the lock member 26.

In the case of the arrangement wherein the lock check valve CVb is provided in the lock releasing passage 35, under a condition wherein the lock control valve 50 is located at the lock releasing position, even if there occurs drop in the oil pressure of the operating oil fed from the hydraulic pump P, this will not lead to drop in the pressure of the lock recess 25. Consequently, the lock releasing state can be maintained effectively.

### [Other Embodiments]

Aside from the above-described embodiment, following arrangements are also possible (in the following discussion, those having the same functions as the foregoing embodiment will be denoted with same numerals/marks as the foregoing embodiment).

(a) As shown in FIG. 6, both the phase control valve 40 and the lock control valve 50 are configured as the “second valve” operable by a pilot pressure. And, in order to control the pilot pressures for operating the above, there is provided a first valve 60 whose position is electromagnetically changed. In the case of this arrangement, the phase control valve 40 and the lock control valve 50 are provided as two-position switching type and the first valve 60 is switched to one of four positions by setting of electric power supply to the electromagnetic solenoid.

According to the above arrangement, as the control unit G controls the first valve 60, the phase control valve 40 is operated by a pilot pressure, so that the phase control valve 40 realizes feeding/discharging of operating oil to/from the advance chamber Ca and the retard chamber Cb. Further, as the first valve 60 is controlled, the lock control valve 50 is operated by a pilot pressure, thus realizing feeding/discharging of operating oil to/from the lock mechanism L.

In this further embodiment (a), since the first valve 60 is configured to control a pilot pressure, this first valve 60 can be formed compact. Incidentally, although the above drawing shows the lock control valve 50 included in the inner rotor 30, this lock control valve 50 can alternatively be provided outside the rotary system of the device. Further, in the case of the arrangement of this further embodiment (a), some portions of the first valve 60 and the phase control valve 40 or the these valves entirely can be provided in the inner rotor 30, or all the valves can be provided outside the rotary system of the device, as well.

(b) As shown in FIG. 7, the first valve may be provided with the function of the lock control valve 50 (i.e. the first valve acts also as the lock control valve 50) and the phase control valve 40 may be provided as the second valve whose position is switched by a pilot pressure controlled by the above lock control valve 50. In the case of this arrangement, the lock control valve 50 is configured to be switchable among four positions by electric power fed to the electromagnetic solenoid and the phase control valve 40 is configured as a two-position switchable type.

With the above arrangement, as the control unit G controls the lock control valve 50, control of the lock mechanism L is made possible. And, as the pilot pressure is controlled in operative association with the above, the phase control valve 40 is operated. With this operation of the phase control valve 40, feeding/discharging of operating oil to/from the advance chamber Ca and the retard chamber Cb are effected, thus realizing control of the relative rotation phase.

### INDUSTRIAL APPLICABILITY

The present invention is applied to a valve opening/closing timing control device that effects control of a relative rotation phase and control of a lock mechanism by means of fluid pressure.

### REFERENCE SIGNS LIST

1: crankshaft

5: cam shaft (intake cam shaft)

8: passage (feed passage)

20: driving rotary body (outer rotor)

25: lock recess

26: lock member

27: lock urging member (lock spring)

30: driven rotary body (inner rotor)

32: partitioning portion (vane)

35: passage lock releasing passage

36: lock drain passage

37: pilot passage

38: connecting bolt

38a: advance port

38b: retard port

38c: pilot pressure port

40: first valve, second valve, phase control valve

50: second valve, lock control valve

60: first valve, phase control valve

C: fluid pressure chamber

Ca: advance chamber

Cb: retard chamber

CVa: check valve (main check valve)

CVb: check valve (lock check valve)

E: internal combustion engine (engine)

L: lock mechanism

P: fluid pressure pump

X: rotational axis

1. A valve opening/closing timing control device comprising:
a driving rotary body rotatable in synchronism with a crankshaft of an internal combustion engine;
a driven rotary body mounted coaxially with a rotational axis of the driving rotary body and rotatable in unison with a valve opening/closing cam shaft of the internal combustion engine;
an advance chamber and a retard chamber formed by partitioning a fluid pressure chamber defined between the driving rotary body and the driven rotary body by a partitioning portion formed in either one of the driving rotary body and the driven rotary body;
a lock mechanism switchable between a lock state for locking a relative rotation phase of the driven rotary body relative to the driving rotary body to a predetermined lock phase and a lock releasing state for releasing the locking;
a first valve whose position is changeable electromagnetically;
a second valve whose position is changeable by a fluid pressure controlled by the first valve; and
the second control valve being constituted of at least one of a phase control valve configured to control the relative rotation phase by feeding an operating fluid fed from a fluid pressure pump to the advance chamber or the retard chamber and a lock control valve configured to control the lock state of the lock mechanism by feeding the operating fluid fed from the fluid pressure pump to the lock mechanism.

2. The valve opening/closing timing control device of claim 1, wherein:
an advance port communicated to the advance chamber, a retard port communicated to the retard chamber and a pilot pressure port for controlling the fluid pressure together constituting the phase control valve are included in the first valve; and
the lock control valve is configured as the second valve whose position is switched by the fluid pressure from the pilot pressure port.

3. The valve opening/closing timing control device of claim 2, wherein the first valve is arranged such that the advance port and the retard port are disposed in parallel with each other and the pilot pressure port is disposed at a position in subsequent juxtaposition to the advance port and the retard port.

4. The valve opening/closing timing control device of claim 2, wherein a check valve is incorporated in at least one of a passage that feeds the operating fluid from the fluid pressure pump to the first valve and a passage that feeds the operating fluid from the fluid pressure pump to the second valve.

5. The valve opening/closing timing control device of claim 2, wherein:
the lock mechanism includes a lock member that is caused to urgingly protrude from the driving rotary body by a lock urging member and a lock recess that is formed in the driven rotary body to be engageable with the lock member;
the driven rotary body is coupled with the camshaft via a connecting bolt; and
the lock control valve is provided at another portion of the driven rotary body than the connecting bolt.

6. The valve opening/closing timing control device of claim 2, wherein the lock control valve includes a valve body that is movably inserted to a hole portion that is defined in the driven rotary body along an axis extending parallel with the rotational axis.

7. The valve opening/closing timing control device of claim 6, wherein:
a lock releasing passage that releases the lock state by feeding the operating fluid from the lock control valve to the lock mechanism, a lock draining passage that maintains the lock state by discharging the operating fluid from the lock mechanism via the lock control valve and a pilot passage that applies a pilot pressure to the lock control valve are formed in the driven rotary body; and
the lock releasing passage, the lock draining passage and the pilot passage are formed parallel with each other in the above-recited order.
